(19) United States
(12) Patent Application Publication
(10) Pub. No.: US 2011/0250573 A1
(43) Pub. Date: Oct. 13, 2011

(54) PACKING WORKSPACE TOOL AND METHOD FOR MATH LEARNING

(76) Inventors: Mickelle Weary, Kirkland, WA (US); Catherine Twomey Fosnot, New London, CT (US); Beth Dudycha, Mercer Island, WA (US); Laura Koch, Seattle, WA (US); David Fedchenko, Seattle, WA (US); Nigel J. Green, Bellevue, WA (US); Aja M. Hammerly, Seattle, WA (US); Daniel R. Kerns, Mercer Island, WA (US); Rebecca M. Lewis, Tacoma, WA (US); Slavi Marinov Marinov, Varna (BG); Valentin Mihov, Sofia (BG); Petia Radeva, Sofia (BG)

(21) Appl. No.: 13/082,357

(22) Filed: Apr. 7, 2011

Related U.S. Application Data
(60) Provisional application No. 61/321,843, filed on Apr. 7, 2010.

(51) Int. Cl. G09B 5/00

(52) U.S. Cl. 434/188

(57) ABSTRACT

A computer-implemented method for teaching math is disclosed. The method comprises generating a number; generating movable items corresponding to the number defining a number of place values for representing the number; graphically marking place value areas corresponding to the place values; allowing a user to move the movable items into the place value areas to represent the number in terms of its place values.

This application claims the benefit of priority of U.S. 61/321,843, filed Apr. 7, 2010, the entire specification of which is hereby incorporated herein by reference.

### FIELD

Embodiments of the present invention relate generally to software and systems designed for teaching purposes.

### BACKGROUND OF THE INVENTION

Concrete or physical manipulatives such as blocks, math racks, counter, etc., are used to facilitate learning, especially in the field of mathematics. Virtual manipulatives refer to digital “objects” that are the digital or virtual counterpart of concrete manipulatives. Virtual manipulatives may be manipulated, e.g., with a pointing device such as a mouse during learning activities.

### SUMMARY

Broadly, embodiments of the invention disclose a packing workspace tool and a method for teaching math based on the packing workspace tool. The packing workspace tool provides a user with a number of counters in a workspace that is divided into columns. The user may manipulate the counters to create-different representations of a given number. The user types an answer either into a place value chart (described in more detail below) or, in some cases, in a box under each column. Advantageously, the packing workspace tool provides a visual representation of place value and encourages students to be flexible in thinking about numbers. It also moves students toward an understanding of expanded notation.

### BRIEF DESCRIPTION OF THE DRAWINGS

FIGS. 1-9 show screenshots of a User Interface generated by the packing workspace tool and system of the present invention.

FIG. 9 shows an example of hardware that may be used to implement the packing workspace tool in accordance with one embodiment of the invention

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrases “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

Broadly, embodiments of the invention disclose a packing workspace tool and a method for teaching math based on the packing workspace tool. The packing workspace tool provides a user with a number of counters in a workspace that is divided into columns. The user may manipulate the counters to create different representations of a given number. The user types an answer either into a place value chart (described in more detail below) or, in some cases, in a box under each column. Advantageously, the packing workspace tool provides a visual representation of place value and encourages students to be flexible in thinking about numbers. It also moves students toward an understanding of expanded notation.

Advantageously, in one embodiment the packing workspace tool may be rendered as a virtual manipulative on a display screen so that a learner may interact with the virtual manipulative to solve math problems and to learn math problem solving techniques.

The packing workspace tool may be integrated in a system for teaching math. The system may be realized, in one embodiment, as a general-purpose computer comprising suitable instructions for implementing the packing workspace tool and associated method.

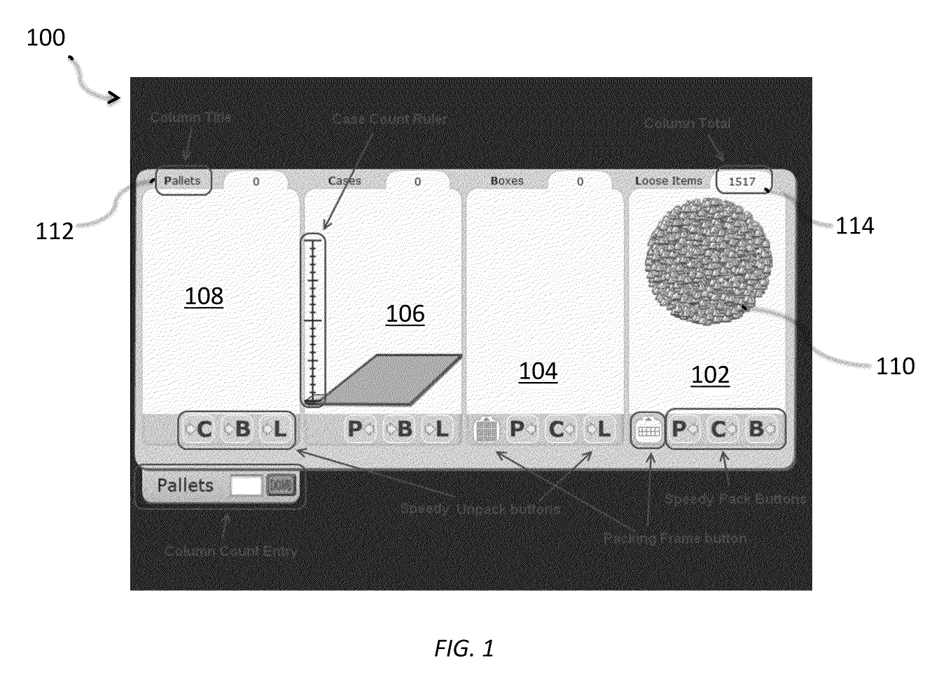

The functioning of the packing workspace tool in accordance with various embodiments of the invention will now be described with reference to FIGS. 1-9 of the drawings. In FIG. 1-8 the same reference numerals are used to indicate the same or similar components/features.

Referring to FIG. 1, there is shown a UI 100 for a packing workspace in accordance with one embodiment of the invention. The UI 100 comprises a number of columns 102 to 108. The column 102 comprises a plurality of loose counters 110. Each of the columns 102 to 108 represents a different place value. The columns 102, 104, 106, and 108 represent ones, tens, hundreds, and thousands, respectively.

Each column has column title 112 and a column total counter 114. In the case of the embodiment shown in FIG. 1, the column 102 has the label “Loose Items”, column 104 has the label “Boxes”, column 106 has the label “Cases”, and column 108 has the label “Pallets”.

In the example shown in FIG. 1, there is a total of 1517 loose items shown in column 102. The goal is to pack the loose items into the different columns in an optimal manner. The packing process is facilitated by speedy pack button, speedy unpack buttons, and packing frames. For example, the column 102 includes speedy pack buttons “P”, “C”, and “B”. Selection of the speedy pack button “P” will cause a pallet of loose items (i.e. 1000) to be packed in a pallet into column 108. Likewise selection of the speedy pack button “C” will pack a case (i.e. 100) of loose items into column 106, and selection of the speedy pack button “B” will pack a box (i.e. 10) of loose items into the column 104. Columns may have speedy unpack buttons labeled “C”, “B”, and “L”, respectively. These buttons perform the opposite function of the speedy pack buttons. For example, selecting the speedy unpack button “B” from the column 108, will cause a box of items to be moved to the box column 104.

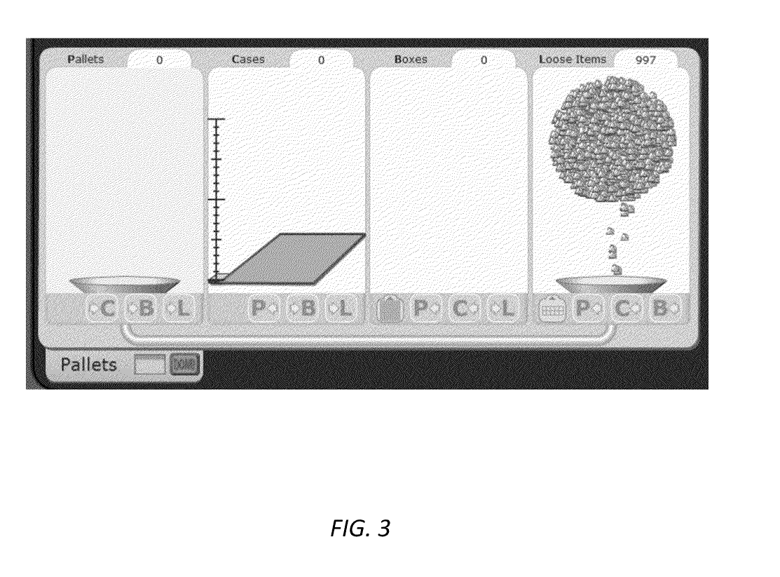

Thus, users may use the “speedy pack” buttons to quickly pack groups of ten, 100, or 1000 and move them to the appropriate column and users may use the “speedy unpack” buttons to quickly unpack groups of ten, 100, or 1000 into the appropriate column. FIG. 3 illustrates speedy packing of 1000 items. Once students trust how many items make up a box, case and pallet they will look for more efficient ways of working with the items. Allowing them to use the speedy packing buttons moves them from the tedious job of counting individual items to the more efficient strategy of counting items by landmark numbers such as 5, 10, 100, etc.

In one embodiment, users may pack items by dragging one at a time to a “packing area” which includes a frame 116 to hold ten items. These items may be single loose items, a box of ten items or a case of 100 items. This forces students to pack items in each column into groups of 10 and therefore reinforces the place value concept for base 10.

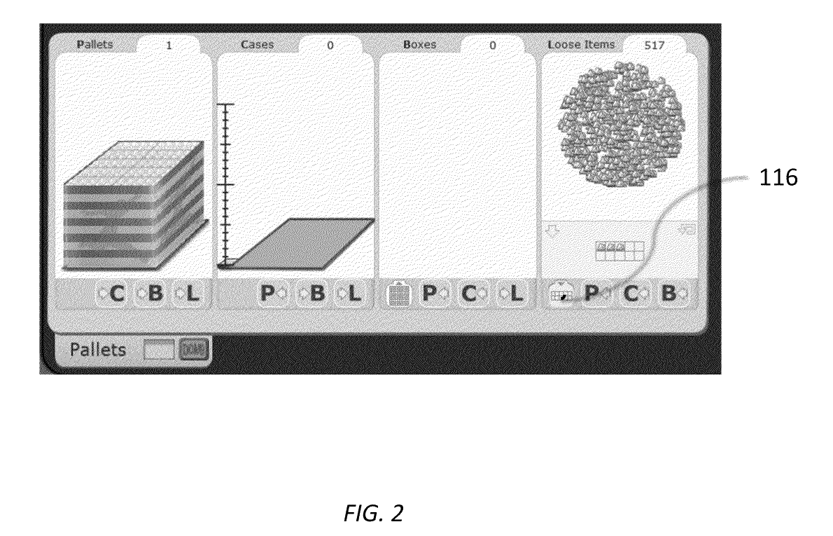

FIG. 2 illustrates manual packing of the frame 116.

In one embodiment, the number of columns shown and the particular columns that are shown may be changed. Advantageously, the change may be based on the skill level of the user. This allows for scaffolding the learning as well as more flexible combinations (e.g. 113 can have 1 ten or it can have 11 tens and 3 ones). For example, the packing workspace tool may be used to show groupings such as tens and ones; hundreds and ones; or thousands, hundreds, tens, ones.

In one embodiment, the packing workspace tool may include a function to determine optimal packing. Optimal packing describes having the maximum number of items in the largest column possible. For example, 93 is optimally packed as 9 tens and 3 loose ones, as opposed to 8 tens and 13 loose ones. The optimal packing function may be selectively turned on and off, in one embodiment.

In one embodiment, the packing workspace tool is able to display/add/subtract items of multiple colors to show addition and subtraction.

In one embodiment the column labels may be changed. For example instead of the labels loose items, boxes, cases and pallets, the labels thousands, hundreds, tens, and ones may be used.

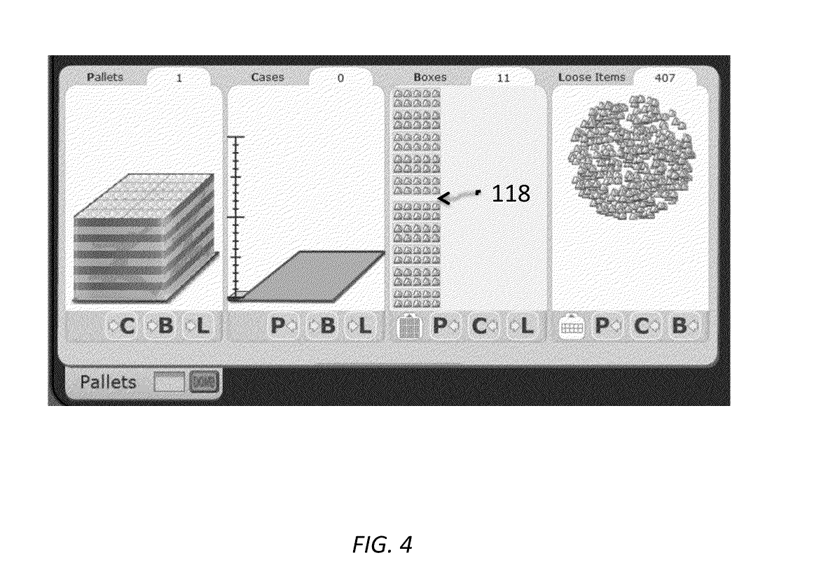

FIG. 4 shows an embodiment where boxes as displayed in groups of ten. As the boxes are added to the column 104, the columns of 10 are created automatically by placing each box in order. There is a space 118 between each group of 5 boxes. This reinforces counting using the 5 and 10 structures.

The embodiment of FIG. 4 also shows cases as groups of 10 boxes. This reinforces the place value concept that one hundred is made up of 10 tens.

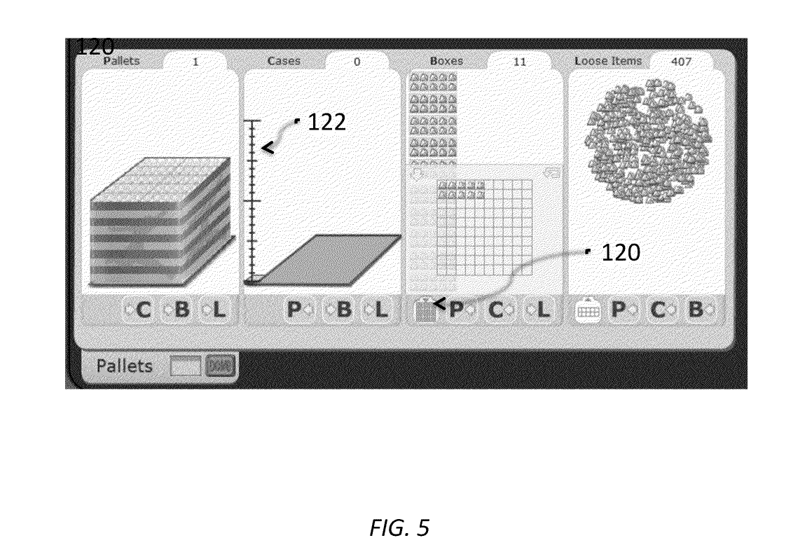

FIG. 5 illustrates manual packing of 10 boxes each having 10 items using frame button 120. The cases are in alternating colors with an adjacent ruler 122 to enable students to efficiently count the number of cases. The ruler 122 emphasizes 5's and 10's to aid counting.

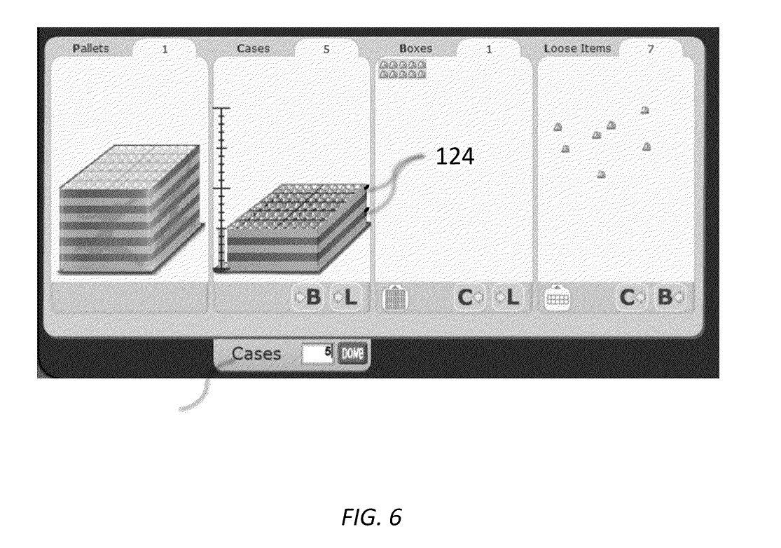

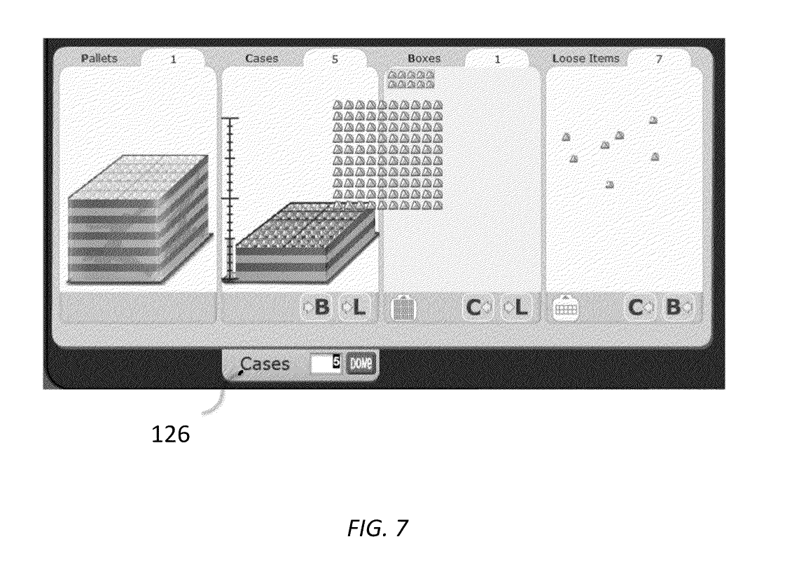

FIG. 6 illustrates an embodiment in which different colors are used to emphasize each layer 124 of boxes. Users may unpack items by dragging them to a column to the right as is shown in the example of FIG. 7.

In FIG. 7, pallets are displayed as a see-through wrapped group of 10 cases. “Wrapping” the pallet reinforces the stack of 10 cases as a unit. By allowing students to see the top case made up of 10 boxes, they are able to count the items to prove the amount.

In one embodiment total labels e.g. label 126 in FIG. 7 may be selectively turned on/off for each column. This allows students to see the number of units and connects the visual representation to the place value and/or place value chart (described in more detail below).

In one embodiment the number in each column may be shown on top of the items. This reinforces the connection between the workspace column and the place value.

### Buildable Place Value Workspace

In one embodiment referred to as “the Buildable Place Value Workspace”, users are allowed to build numbers and addition and subtraction situations by placing and/or removing objects displayed in groups of thousands, hundreds, tens and ones from a bin into the appropriate column on the workspace. The user can create numbers from zero (add objects to a blank workspace) or from a given number. The buildable Place Value Workspace may support display and manipulation of multiple types of items on the same workspace so that, for example, two different numbers summing to a total can be displayed and clearly differentiated.

The Buildable Place Value Workspace is able to assess the number of moves that will allow for tracking optimal building. (For example, building 299 optimally would be 300 take away 1 one; non-optimal could be 2 hundreds, 9 tens and 9 ones)

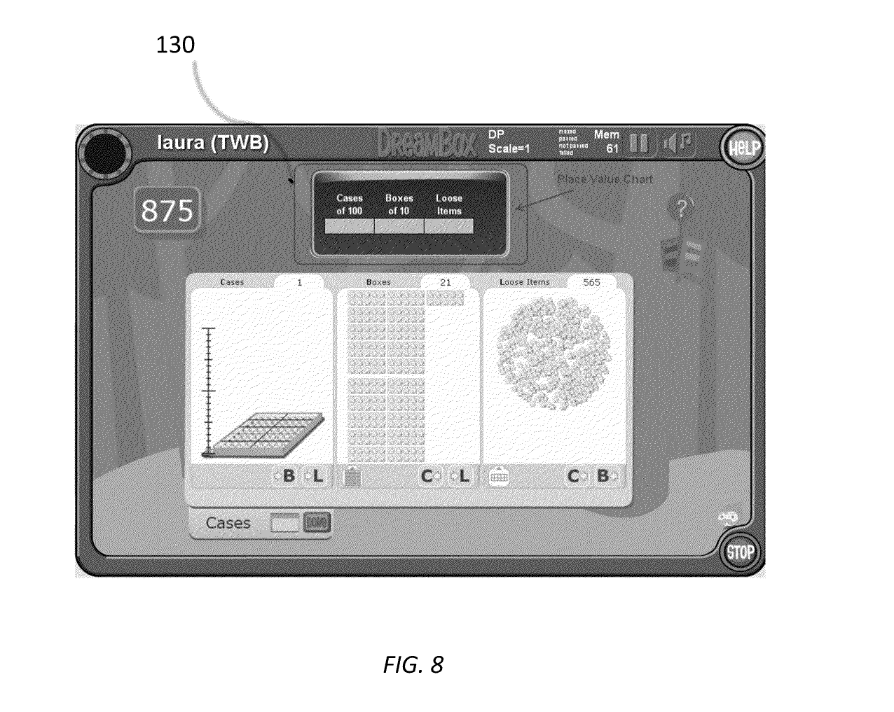

FIG. 8 shows an embodiment with a place value chart 130. The place value chart includes labeled columns to show values being manipulated within the workspace. The place value chart 130 may be used to assess specific mistakes and specific feedback relating to those mistakes. For example, one implementation might support the following mistakes: Added target to start value, Off by 1, Off by 10, Off by 100, Off by 1000, Off by 2, Place value add up, Place value dropped zero, Place value extra zero, Place value ignored column, Place value multiplied out, Place value not optimal, Place value off by place value, Place value reversal columns, Place value reversal digits, Place value total in all, Place value total in hundreds, Place value total in tens, No answer given, Generic mistake)

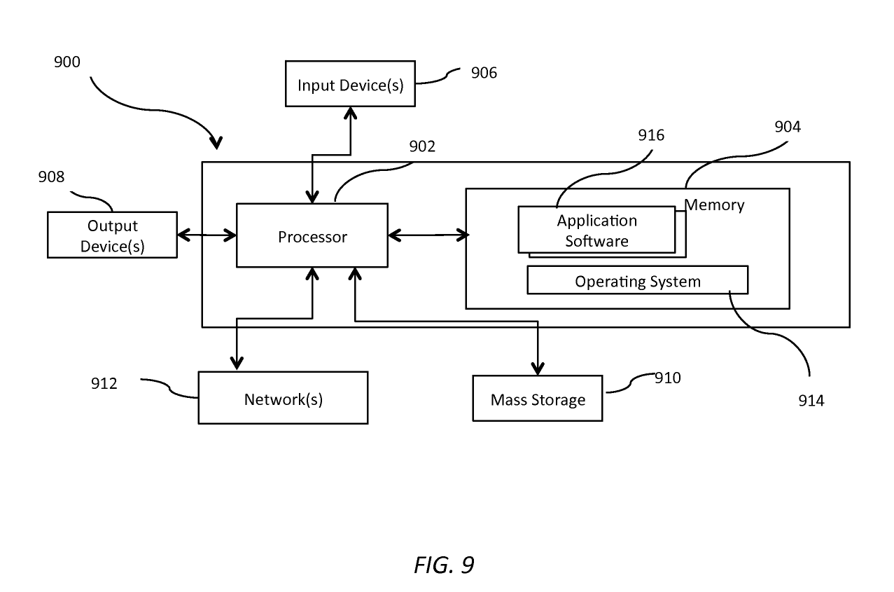

FIG. 9 shows an example of a computer system 900 for implementing the packing workspace tool described herein. The system 900 may include at least one processor 902 couple to a memory 904. The processor 902 may represent one or more processors (e.g., microprocessors), and the memory 904 may represent random access memory (RAM) devices comprising a main storage of the system 900, as well as any supplemental levels of memory e.g., cache memories, non-volatile or back-up memories (e.g. programmable or flash memories), read-only memories, etc. In addition, the memory 904 may be considered to include memory storage physically located elsewhere in the system 900, e.g. any cache memory in the processor 902 as well as any storage capacity used as a virtual memory, e.g., as stored on a mass storage device 910.

The system 900 also typically receives a number of inputs and outputs for communicating information externally. For interface with a user or operator, the system 900 may include one or more user input devices 906 (e.g., a keyboard, a mouse, imaging device, etc.) and one or more output devices 908 (e.g., a Liquid Crystal Display (LCD) panel, a sound playback device (speaker, etc.).

For additional storage, the system 900 may also include one or more mass storage devices 910, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the system 900 may include an interface with one or more networks 912 (e.g., a local, area network (LAN), a wide area network (WAN), a wireless network, and/or the Internet among others) to permit the communication of information with other computers coupled to the networks. It should be appreciated that the system 900 typically includes suitable analog and/or digital interfaces between the processor 902 and each of the components 904, 906,908, and 912 as is well known in the art.

The system 900 operates under the control of an operating system 914, and executes various computer software applications, components, programs, objects, modules, etc. to implement the techniques described above. Moreover, various applications, components, programs, objects, etc., collectively indicated by reference 916 in FIG. 9, may also execute on one or more processors in another computer coupled to the system 900 via a network 912, e.g. in a distributed computing environment, whereby the processing required to implement the functions of a computer program may be allocated to multiple computers over a network. The application software 916 may include a set of instructions which, when executed by the processor 902, causes the system 900 to generate the packing workspace tool described.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

Although the present invention has been described with reference to specific example embodiments, it will be evident that various modifications and changes can be made to these embodiments without departing from the broader spirit of the invention. Accordingly, the specification and drawings are to be regarded in an illustrative sense rather than in a restrictive sense.

1. A computer-implemented method for teaching math, comprising:
generating a number;
generating movable items corresponding to the number defining a number of place values for representing the number;
graphically marking place value areas corresponding to the place values;
allowing a user to move the movable items into the place value areas to represent the number in terms of its place values.

2. The method of claim 1, further comprising receiving the user's input and evaluating the input.

3. The method of claim 2, wherein evaluating the input comprises assessing the input in terms of an optimal solution defined as a representation of the number in terms with the maximum number of items in place value areas of greatest value.

4. The method of claim 1, further comprising generating at least one speedy pack button to move a defined group of moveable items en masse to a corresponding place value area.

5. The method of claim 1, further comprising generating at least one speedy unpack button to move a defined group of moveable items en masse to a corresponding place value area.

6. The method of claim 1, further comprising a frame to facilitate packing of tens of moveable items.

7. The method of claim 6, wherein the tens of moveable items is selecting from the group consisting of individual moveable items, tens of moveable items, and hundreds of moveable items.

8. The method of claim 1, further comprising generating and displaying a place value chart to represent a number formed by the combined values of the items placed in the place value areas.

9. A system, comprising:
a processor; and
a memory coupled to the processor, the memory storing instructions which when executed by the processor causes the system to perform a method for teaching math, comprising:
generating a number;
generating movable items corresponding to the number defining a number of place values for representing the number;
graphically marking place value areas corresponding to the place values;
allowing a user to move the movable items into the place value areas to represent the number in terms of its place values.

10. The system of claim 9, wherein the method further comprises receiving the user's input and evaluating the input.

11. The system of claim 10, wherein evaluating the input comprises assessing the input in terms of an optimal solution defined as a representation of the number in terms with the maximum number of items in place value areas of greatest value.

12. The system of claim 9, wherein the method further comprises generating at least one speedy pack button to move a defined group of moveable items en masse to a corresponding place value area.

13. The system of claim 9, wherein the method further comprises generating at least one speedy unpack button to move a defined group of moveable items en masse to a corresponding place value area.

14. The system of claim 9, further comprising a frame to facilitate packing of tens of moveable items.

15. The system of claim 14, wherein the tens of moveable items is selecting from the group consisting of individual moveable items, tens of moveable items, and hundreds of moveable items.

16. The system of claim 1, wherein the method further comprises generating and displaying a place value chart to represent a number formed by the combined values of the items placed in the place value areas.

17. A computer-readable medium having stored thereon a sequence of instruction which when executed by a system causes the system to perform a method, comprising:
generating a number;
generating movable items corresponding to the number defining a number of place values for representing the number;
graphically marking place value areas corresponding to the place values;
allowing a user to move the movable items into the place value areas to represent the number in terms of its place values.

18. The computer-readable medium of claim 17, wherein the method further comprises receiving the user's input and evaluating the input.

19. The computer-readable medium of claim 17, wherein evaluating the input comprises assessing the input in terms of an optimal solution defined as a representation of the number in terms with the maximum number of items in place value areas of greatest value.

20. The computer-readable medium of claim 17, wherein the method further comprises generating and displaying a place value chart to represent a number formed by the combined values of the items placed in the place value areas.
